(19) United States
(12) Patent Application Publication
(10) Pub. No.: US 2025/0389084 A1
(43) Pub. Date: Dec. 25, 2025

(54) METHOD FOR PREPARING PULP WITH RELATIVELY HIGH BRIGHTNESS AND HIGH-ACTIVITY LIGNIN

(71) Applicant: QILU UNIVERSITY OF TECHNOLOGY (SHANDONG ACADEMY OF SCIENCES), Jinan (CN)

(72) Inventors: Shuzhen NI, Jinan (CN); Yongchao ZHANG, Jinan (CN); Xiaoqian CHEN, Jinan (CN); Zhaojiang WANG, Jinan (CN); Zongquan LI, Jinan (CN); Menghua QIN, Jinan (CN)

(21) Appl. No.: 18/904,619

(22) Filed: Oct. 2, 2024

(30) Foreign Application Priority Data
Jun. 20, 2024 (CN) 202410802953.3

(51) Int. Cl. D21C 3/22; C07G 1/00; D21H 11/12

(52) U.S. Cl. CPC D21C 3/222; C07G 1/00; D21H 11/12

(57) ABSTRACT

A method for preparing a pulp with relatively high brightness and a high-activity lignin is provided, belonging to the field of pulp and papermaking engineering. In the method, a lignin precursor and a polyol are added during the cooking of a raw material to obtain the pulp with relatively high brightness. In the method, the lignin precursor and the polyol form a nucleophilic combination (including active organic small molecules containing short chains and aromatic moieties) during delignification, which undergoes a saturated condensation reaction on a side chain position of the lignin.

### CROSS REFERENCE TO RELATED APPLICATION

This patent application claims the benefit and priority of Chinese Patent Application No. 2024108029533, entitled “Method for preparing pulp with relatively high brightness and high-activity lignin” filed on Jun. 20, 2024, the disclosure of which is incorporated by reference herein in its entirety as part of the present application.

### TECHNICAL FIELD

The present disclosure belongs to the field of pulp and papermaking engineering, and particularly relates to a method for preparing a pulp with relatively high brightness and a high-activity lignin by adding a lignin precursor small molecule and a short-chain polyol during the cooking of a raw material.

### BACKGROUND

Information disclosed in this background section is merely for the purpose of facilitating the understanding of the general background of the present disclosure, and is not necessarily regarded as an acknowledgment or any form of implication that the information constitutes the prior art already known to those of ordinary skill in the art.

pulp and papermaking industry consumes a huge quantity of wood fiber raw materials. In traditional pulping processes, cellulose in the wood fiber raw materials is mainly utilized, while the other two main components (namely, hemicellulose and lignin) are not fully utilized. Based on the concept of biomass refining, it is both a severe challenge and a rare development opportunity for the traditional pulp and papermaking industry to explore an efficient separation technology of all components of wood fiber raw materials. Based on the concept of biomass refining, the development of new and efficient wood fiber separation technology should compromise two principles: (1) selectively and efficiently separating the main components of wood fiber raw materials to obtain products such as cellulose pulp, hemicellulose, and lignin; (2) the separated components being easily further processed into high value-added products. On this basis, a biomass refining platform for high-value utilization of wood fiber is constructed.

In the pulp and papermaking industry that consumes a huge quantity of wood fiber raw materials, about 80% to 90% of the lignin is removed from the raw materials and dissolved into a cooking liquid during the pulp and papermaking. The unremoved lignin remains in the cellulose pulp, causing the pulp to appear brown in color with a brightness of 20% to 30% ISO (i.e., determined by ISO 2470-1:2016). High-value applications of cellulose pulp, such as dissolving pulp, generally require higher cellulose purity or brightness. The existing conventional preparation process of dissolving pulp includes three stages: pretreatment, cooking, and bleaching. A brown pulp obtained after the cooking needs to go through 4 to 6 bleaching stages to further remove the lignin remaining in the pulp, thus improving the purity or brightness of the cellulose pulp. The bleaching of the pulp consumes a large quantity of chemicals such as hypochlorite, chlorine dioxide, sodium hydroxide, and hydrogen peroxide. According to statistics, hydrogen peroxide used for pulp bleaching accounts for 50% of a total production (about 1.1 million tons) in the world annually. In addition, a large amount of wastewater generated during the bleaching is the main source of wastewater in the pulp and papermaking industry as well as the main target of environmental risk management.

Therefore, by improving the existing lignocellulose separation technology, the lignin removal rate would be improved, and the content of lignin remaining in the pulp would be reduced, resulting in that a pulp with relatively high brightness could be directly obtained through separation. Also, the subsequent bleaching and the dosage of bleaching chemicals would thereby be effectively reduced, and meanwhile a high-activity lignin and hemicellulose are obtained. In view of this, it is of significance to improve the existing lignocellulose separation technology in terms of realizing the high-value resource utilization and industrialization of biomass.

Chinese publication No. CN111958730A discloses a method for inhibiting lignin condensation. In the method, a small-molecule phenolic organic compound is used to replace large-molecule lignin, and preferentially reacts with active sites of the lignin to increase the efficiency of delignification. Chinese publication No. CN109706769A discloses a method for separating lignocellulose by using a mixture of a small-molecule aldehyde organic compound and an organic acid. In the method, the mixture of the small-molecule aldehyde organic compound and the organic acid was mixed with a wood fiber raw material and the resulting mixture was then cooked at a high temperature to increase a lignin removal rate. However, an effect of the above methods on improving pulp brightness still needs to be improved.

### SUMMARY

In order to solve the above problems, the present disclosure provides a method for preparing a pulp with relatively high brightness and a high-activity lignin. The present disclosure aims to improve a lignin removal rate of wood fiber biomass components and directly obtain a pulp with relatively high brightness and a high-activity lignin. During the cooking, a lignin precursor small-molecule and a short-chain polyol are added. During the delignification, the lignin precursor small-molecule and short-chain polyol could form a nucleophilic combination (including active organic small molecules containing short chains and aromatic moieties), which undergoes saturated condensation reaction on the side chain positions of lignin. That is to say, the lignin precursor small-molecule and short-chain polyol form the nucleophilic combination to react with as many electrophilic active sites of a lignin intermediate as possible. After occupying these electrophilic sites of the lignin intermediate, the lignin intermediate loses its reactivity, thereby blocking a reaction between the electrophilic sites of the lignin intermediate and the nucleophilic sites of the lignin molecules per se, and then preventing condensation reaction between the lignin molecules. As a result, a molecular weight of dissolved lignin could be reduced, and the dissolution of lignin from a cell wall of the raw material could be promoted, thereby reducing the residual lignin in the cellulose pulp, and improving a purity of cellulose. In this way, unbleached pulp with relatively high brightness could be directly obtained, as well as a high-activity lignin and hemicellulose products.

In the present disclosure, it is found that the linking bonds in a lignin structure are mainly β-O-4 aromatic ether bonds (accounting for 40% to 60%), and there are also ether bonds such as α-O-4 and 4-O-5 ether bonds, as well as carbon-carbon bonds such as β-1, 5-5, and β-β carbon-carbon bonds. During the delignification, lignin is degraded from the raw materials and dissolved into a reaction system. The degradation is a process of breaking different linking bonds in the lignin structure, and these degradation reactions occur in a disordered manner. The breaking of an α-aryl ether bond and a β-aryl ether bond in the lignin structure is the main ways for lignin to be degraded and dissolved. In addition to fragmented degradation, lignin also undergoes intramolecular and intermolecular condensation reactions. These condensation reactions mainly include: (1) a reaction between a carbon cation at the C-α position of a lignin reaction intermediate and an active site of a benzene ring of other lignin units (C5 and C6 sites) to form an intermolecular condensation structure; (2) a reaction by an attack of the carbon cation at the C-α position on the benzene rings of adjacent lignin units to generate new carbon-carbon bonds and thereby form a benzofuran intramolecular condensation structure. These condensation reactions also occur in a disordered manner, in which the intermolecular condensation reaction could cause the lignin fragments to be reconnected into macromolecules through carbon-carbon bonds, thereby increasing a relative molecular weight of the lignin. The carbon cation at the C-α position of lignin serves as a key active intermediate during the degradation and condensation reactions of lignin. The lignin precursor small-molecule organic compound could preferentially react with the carbon cation at the C-α position of lignin due to high chemical reactivity to a certain extent. The addition of the short-chain polyol could further promote the condensation reaction of the short-chain polyol as well as the lignin precursor small-molecule organic compound with the carbon cation at the C-α position of lignin, thereby fulfilling saturated condensation reaction of the carbon cation at the C-α position of a lignin side chain. The addition of the short-chain polyol could also compensate the obstacles to the reaction caused by a spatial structure of the lignin precursor small molecule. During the delignification, a nucleophilic combination of the lignin precursor small molecule and the short-chain polyol could more effectively reduce the activity of lignin molecular intermediate (carbon cation at the C-α position of lignin) to form a stable lignin molecule, which reduces disordered condensation reactions between lignin molecules, that is to say, reduces the relative molecular weight of dissolved lignin, thereby promoting the removal of lignin. Furthermore, the process is conducive to obtaining high-activity lignin with a low molecular weight and rich functional groups.

To achieve the above object, the present disclosure adopts the following technical solutions:

A first aspect of the present disclosure provides a method for preparing a pulp with relatively high brightness and a high-activity lignin, including:
subjecting a lignocellulose raw material to high-temperature treatment in the presence of a lignin precursor small-molecule organic compound, a short-chain polyol, and a cooking agent to obtain the pulp with relatively high brightness and the high-activity lignin; where
the lignin precursor small-molecule organic compound has one benzene ring and is at least one selected from the group consisting of guaiacol, eugenol, m-methoxyphenol, p-methoxyphenol, p-hydroxybenzaldehyde, benzaldehyde, vanillin, and syringaldehyde; and
a mass ratio of the lignin precursor small-molecule organic compound, the short-chain polyol, and the cooking agent is in a range of (1-2):(1-5):(7-9.5).

In the present disclosure, a cooking liquid composed of the cooking agent and the lignin precursor small-molecule organic compound in a certain ratio is added to conduct the high-temperature treatment on the lignocellulose raw material. The high-temperature treatment is intended for pulp and papermaking, and also for comprehensive utilization of biomass.

In some embodiments, the short-chain polyol is at least one selected from the group consisting of ethylene glycol, propylene glycol, butylene glycol, and glycerol.

The cooking agent may be a solvent used in conventional separation methods in the prior art and has a conventional concentration. Therefore, in some embodiments, the cooking agent is at least one of formic acid, acetic acid, methanol, ethanol, sodium sulfide, sodium sulfite, and sodium hydroxide.

In some embodiments, a ratio of a mass of the cooking agent to a total mass of the lignin precursor small-molecule organic compound and the short-chain polyol is in a range of (5-95):(95-5).

In some embodiments, a ratio of a mass of the cooking agent to a total mass of the lignin precursor small-molecule organic compound and the short-chain polyol is in a range of (7-8):(1-1.5).

In some embodiments, a mass ratio of the lignin precursor small-molecule organic compound to the short-chain polyol is in a range of (5-95):(95-5).

In some embodiments, a mass ratio of the lignin precursor small-molecule organic compound to the short-chain polyol is in a range of (1-2):1.

In some embodiments, the high-temperature treatment is conducted with a material-to-feed liquid mass ratio of 1:4 to 1:20, preferably 1:4 to 1:10, and more preferably 1:7 to 1:10.
in some embodiments, the high-temperature treatment is conducted at a temperature of 60° C. to 200° C., preferably 80° C. to 170° C., and more preferably 130° C. to 140° C.

In some embodiments, the high-temperature treatment is conducted for 10 min to 900 min, preferably 10 min to 180 min, and more preferably 30 min to 60 min.

In some embodiments, a temperature raising rate is in a range of 5° C./min to 10° C./min.

In some embodiments, the method further includes: after the high temperature separation, subjecting a resulting mixture to solid-liquid separation to obtain a solid and a black liquor;
preparing a pulp using the solid; and
extracting the high-activity lignin and optional hemicellulose from the black liquor, and recycling the cooking agent and the lignin precursor small-molecule organic compound.

In specific embodiments, extraction of the lignin and optional hemicellulose is conducted by conventional extraction methods, for example, after reduced-pressure evaporation and concentration, water is added thereto and precipitation occurs, to obtain lignin, and the hemicellulose dissolved in the water phase could be obtained after drying.

In some embodiments, a process for cycling the cooking agent includes/consists of evaporating at a reduced pressure and then conducting multi-effect extraction and distillation to separately obtain the cooking agent.

In some embodiments, the lignocellulose raw material includes a wood (such as aspen wood, eucalyptus wood, and acacia wood) and a non-wood fiber raw material (such as bamboo, rice straw, wheat straw, and corn stalk).

A second aspect of the present disclosure provides a pulp with relatively high brightness prepared by the method as described above.

A third aspect of the present disclosure provides use of a lignin precursor small-molecule organic compound and a short-chain polyol in improving pulp brightness.

Some embodiments of the present disclosure have the following beneficial effects:

(1) In the present disclosure, during the cooking of raw material(s), the addition of the lignin precursor small-molecule organic compound and the short-chain polyol could reduce the molecular weight of lignin dissolved, increase the number of functional groups in lignin, promote the dissolution of lignin, and improve the purity of cellulose, thereby directly obtaining the pulp with relatively high brightness and the high-activity lignin.

(2) In the present disclosure, a removal rate of lignin in the raw material(s) is improved meanwhile the amount of residual lignin and chemicals in the cellulose pulp is reduced.

(3) In the present disclosure, the blended cooking liquid and the lignin precursor small-molecule organic compound are easy to recycle and reuse, with a simple operation process and low production cost.

(4) In the present disclosure, the method is simple, practical, and easy to promote.

### DETAILED DESCRIPTION OF THE EMBODIMENTS

It should be pointed out that the following detailed description is illustrative and is intended to provide further description of the present disclosure. Unless otherwise specified, all technical and scientific terms used in the present disclosure have the same meaning as commonly understood by one of ordinary skill in the technical field to which the present disclosure pertains.

The present disclosure will be further described below in detail in conjunction with specific examples, and it should be pointed out that the specific examples are an explanation but not a limitation of the present disclosure.

Unless otherwise specified, the content of each component used in the following examples is the mass percentage.

### Example 1

Wood fiber raw material: aspen wood chips, with a length and a width each being 2.0 cm to 4.0 cm, and a thickness being 0.5 cm to 1.0 cm;

Cooking vessel: Hastelloy reactor, heated by a heating jacket with programmed temperature control.

TABLE 1
Formulas for cooking:

| | Aspen wood | | | | | | Short- |
|---|---|---|---|---|---|---|---|
| | chips | Cooking agent (g) | | | | | chain |
| | (absolutely | 90% | 90% | Lignin precursor small molecule (g) | | | polyol (g) |
| | dry), | formic | acetic | | | p- | Ethylene |
| Material | g | acid | acid | Guaiacol | Eugenol | hydroxybenzaldehyde | glycol |
| | Amount | | | | | | |
| Formula | 100 | 950 | 0 | 25 | 0 | 0 | 25 |
| 1 | | | | | | | |
| Formula | 100 | 900 | 0 | 50 | 0 | 0 | 50 |
| 2 | | | | | | | |
| Formula | 100 | 800 | 0 | 100 | 0 | 0 | 100 |
| 3 | | | | | | | |
| Formula | 100 | 700 | 0 | 150 | 0 | 0 | 150 |
| 4 | | | | | | | |
| Formula | 100 | 700 | 0 | 100 | 0 | 0 | 200 |
| 4-1 | | | | | | | |
| Formula | 100 | 700 | 0 | 50 | 0 | 0 | 250 |
| 4-2 | | | | | | | |
| Formula | 100 | 450 | 350 | 100 | 0 | 0 | 100 |
| 5 | | | | | | | |
| Formula | 100 | 450 | 450 | 25 | 0 | 0 | 25 |
| 6 | | | | | | | |
| Formula | 100 | 700 | 0 | 0 | 150 | 0 | 150 |
| 7 | | | | | | | |
| Formula | 100 | 700 | 0 | 0 | 0 | 150 | 150 |
| 8 | | | | | | | |
| Formula | 100 | 700 | 0 | 100 | 50 | 50 | 100 |
| 9 | | | | | | | |
| Formula | 100 | 700 | 0 | 100 | 100 | 0 | 100 |
| 10 | | | | | | | |
| Formula | 100 | 700 | 0 | 100 | 0 | 100 | 100 |
| 11 | | | | | | | |
| Formula | 100 | 700 | | 0 | 100 | 100 | 100 |
| 12 | | | | | | | |
| Control | 100 | 1000 | 0 | 0 | 0 | 0 | 0 |
| 1 | | | | | | | |
| Control | 100 | 800 | 0 | 200 | 0 | 0 | 0 |
| 2 | | | | | | | |
| Control | 100 | 800 | 0 | 0 | 0 | 0 | 200 |
| 3 | | | | | | | |
| Control | 100 | 800 | 0 | 100 | 0 | 0 | 100 |
| 4 | | | | | | | |
| Control | 100 | 800 | 0 | 100 | 0 | 0 | 100 |
| 5 | | | | | | | |
| Control | 100 | 800 | 0 | 100 | 0 | 0 | 100 |
| 6 | | | | | | | |
| Control | 100 | 800 | 0 | 100 | 0 | 0 | 100 |
| 7 | | | | | | | |
| Control | 100 | 800 | 0 | 100 | 0 | 0 | 100 |
| 8 | | | | | | | |
| Control | 100 | 800 | 0 | 100 | 0 | 0 | 100 |
| 9 | | | | | | | |

In Control 4, guaiacol was replaced with resorcinol; in Control 5, ethylene glycol was replaced with ethanol; in Control 6, ethylene glycol was replaced with propylene glycol; in Control 7, ethylene glycol was replaced with butylene glycol; in Control 8, ethylene glycol was replaced with a combination of ethylene glycol and propylene glycol (at a mass ratio of 1:1); and in Control 9, ethylene glycol was replaced with a combination of butylene glycol and glycerol (at a mass ratio of 1:1).

### Cooking Process:

a. A blended cooking liquid (a cooking agent+a lignin precursor small molecule+a short-chain polyol) and aspen wood chips of a formula in Table 1 were charged into a reactor, a resulting mixture was heated to 140° C. at a raising rate of 5.0° C./min, and cooked at the highest temperature for 45 min.

b. The resulting mixture after cooking was subjected to solid-liquid separation to obtain a solid and a black liquor. The solid was washed and screened to obtain a pulp.

c. The cooking agent, saccharides, lignin and other chemical products were recycled from the black liquor, where the lignin was recycled by reduced-temperature evaporation and concentration, and then adding water thereto for precipitation.

The cooking agent was obtained through reduced-pressure evaporation and multi-effect extraction and distillation, and then reused.

TABLE 2
Properties of separated products

| | Items | | | | |
|---|---|---|---|---|---|
| | | | | Relative | |
| | Pulp | Kappa | Brightness/% | molecular weight | Lignin |
| Samples | yield/% | number | ISO | of lignin (MW) | yield/% |
| Formula | 40 | 14 | 67 | 16390 | 24.5 |
| 1 | | | | | |
| Formula | 39.5 | 13 | 70 | 14956 | 25.5 |
| 2 | | | | | |
| Formula | 38.5 | 12 | 76 | 11287 | 26.5 |
| 3 | | | | | |
| Formula | 38 | 6 | 79 | 8380 | 27 |
| 4 | | | | | |
| Formula | 38.3 | 8 | 75 | 8880 | 27 |
| 4-1 | | | | | |
| Formula | 38.8 | 9.5 | 73 | 9380 | 27 |
| 4-2 | | | | | |
| Formula | 40 | 8 | 66 | 9078 | 23.5 |
| 5 | | | | | |
| Formula | 41 | 16 | 60 | 18560 | 22.5 |
| 6 | | | | | |
| Formula | 42 | 19 | 58 | 20258 | 21.5 |
| 7 | | | | | |
| Formula | 39 | 15 | 69 | 17210 | 24.5 |
| 8 | | | | | |
| Formula | 39.5 | 16 | 70 | 17241 | 23.5 |
| 9 | | | | | |
| Formula | 39.5 | 13 | 75 | 13247 | 25.5 |
| 10 | | | | | |
| Formula | 38.5 | 14 | 73 | 15234 | 25.5 |
| 11 | | | | | |
| Formula | 39.5 | 15 | 73 | 17266 | 24.5 |
| 12 | | | | | |
| Control | 44.5 | 55 | 20 | 50580 | 18.5 |
| 1 | | | | | |
| Control | 42.5 | 45 | 32 | 45550 | 19.2 |
| 2 | | | | | |
| Control | 44.5 | 43 | 34 | 43230 | 18.8 |
| 3 | | | | | |
| Control | 43.6 | 39 | 43 | 40253 | 19.5 |
| 4 | | | | | |
| Control | 44.2 | 41 | 36 | 41875 | 19.0 |
| 5 | | | | | |
| Control | 38.8 | 14 | 74 | 16211 | 25.1 |
| 6 | | | | | |
| Control | 39.0 | 15 | 72 | 16758 | 24.8 |
| 7 | | | | | |
| Control | 39.2 | 13 | 75 | 13254 | 25.5 |
| 8 | | | | | |
| Control | 39.4 | 16 | 70 | 16985 | 23.2 |
| 9 | | | | | |

Note:
In Table 2, Brightness/% ISO represents brightness determined by ISO 2470-1: 2016.

As can be seen from the comparisons among Formula 1 to Formula 3, as the dosages of lignin precursor small-molecule organic compound and the short-chain polyol increase, the brightness of the pulp gradually increases.

As can be seen from the comparisons among Formula 4 to Formula 4-2, when the ratio of lignin precursor small-molecule organic compound to the short-chain polyol was 1:1, there was the highest brightness of pulp.

As can be seen from the comparison between Formula 3 and Formula 5, compared with the formic acid alone, the combination of formic acid and acetic acid has a poor effect on lignin removal and results in reduced brightness of the pulp.

As can be seen from the comparison between Formula 1 and Formula 6, as the total acid dosage decreases, the pulp brightness decreases.

As can be seen from the comparisons among Formulas 4, 7, and 8, compared with eugenol and p-hydroxybenzaldehyde, the guaiacol as the lignin precursor small-molecule organic compound could better improve the pulp brightness.

As can be seen from the comparisons among Formula 9 to Formula 12, among the combinations of two or three of guaiacol, eugenol, and p-hydroxybenzaldehyde, the combination of guaiacol and eugenol has a better effect on improving the brightness of the pulp.

As can be seen from the comparisons among Formula 3 and Control 1 to Control 3, the addition of the lignin precursor small-molecule organic compound and the short-chain polyol effectively improves the brightness of the pulp. Compared with those with the lignin precursor small-molecule organic compound or the short-chain polyol added alone, the nucleophilic combination resulted from the simultaneous addition of the two could significantly improve the brightness of the pulp.

As can be seen from the comparison between Formula 3 and Control 4, the brightness of the pulp decreases significantly after replacing guaiacol with resorcinol.

As can be seen from the comparison between Formula 3 and Control 5, the brightness of the pulp decreases significantly after replacing ethylene glycol with ethanol.

As can be seen from the comparisons among Formula 3 and Control 6 to Control 9, the addition of the short-chain polyol, such as ethylene glycol, propylene glycol, butylene glycol, as well as a mixture of ethylene glycol and propylene glycol and a mixture of butylene glycol and glycerol, could reduce the relative molecular weight of lignin to a certain extent and improve the brightness of the pulp, among which ethylene glycol has the best effect.

In summary, compared with the cooking without adding additives or adding a single additive, the addition of a composite solution including a lignin precursor small molecule and a short-chain polyol could significantly reduce the relative molecular weight of lignin and improve the brightness of the pulp. This indicates that the content of residual lignin in the pulp is effectively reduced and a pulp with relatively high brightness is obtained.

The above description is merely preferred embodiments of the present disclosure and is not intended to limit the present disclosure, and various changes and modifications of the present disclosure may be made by those skilled in the art. Any modifications, equivalent substitutions, improvements, and the like made within the spirit and principle of the present disclosure should be within the scope of the present disclosure.

What is claimed is:

1. A method for preparing a pulp and a lignin, comprising:
subjecting a lignocellulose raw material to high-temperature treatment in the presence of a lignin precursor organic compound, a polyol, and a cooking agent to obtain the pulp and the lignin, wherein
the lignin precursor organic compound has one benzene ring and is at least one selected from the group consisting of guaiacol, eugenol, m-methoxyphenol, p-methoxyphenol, p-hydroxybenzaldehyde, benzaldehyde, vanillin, and syringaldehyde; and
a mass ratio of the lignin precursor organic compound, the polyol, and the cooking agent is in a range of (1-2):(1-5):(7-9.5).

2. The method as claimed in claim 1, wherein the polyol is at least one selected from the group consisting of ethylene glycol, propylene glycol, butylene glycol, and glycerol.

3. The method as claimed in claim 1, wherein the cooking agent is at least one selected from the group consisting of formic acid, acetic acid, methanol, ethanol, sodium sulfide, sodium sulfite, and sodium hydroxide.

4. The method as claimed in claim 1, wherein a ratio of a mass of the cooking agent to a total mass of the lignin precursor organic compound and the polyol is in a range of (7-8):(1-1.5).

5. The method as claimed in claim 1, wherein a mass ratio of the lignin precursor organic compound to the polyol ranges from 1:1 to 2:1.

6. The method as claimed in claim 1, wherein the high-temperature treatment is conducted at a temperature of 60° C. to 200° C. with a material-to-feed liquid mass ratio of 1:4 to 1:20 for 10 min to 900 min.

7. The method as claimed in claim 1, further comprising:
after the high-temperature treatment, subjecting a resulting mixture to solid-liquid separation to obtain a solid and a black liquor;
preparing a pulp using the solid; and
extracting the lignin and optional hemicellulose from the black liquor, and recycling the cooking agent and the lignin precursor organic compound.

8. The method as claimed in claim 1, wherein the lignocellulose raw material comprises a wood and a non-wood fiber raw material;
optionally, the wood is at least one selected from the group consisting of aspen wood, eucalyptus wood, and acacia wood;
optionally, the non-wood fiber raw material is at least one selected from the group consisting of bamboo, rice straw, wheat straw, and corn stalk.

9. A pulp prepared by the method as claimed in claim 1.

10. The pulp as claimed in claim 9, wherein the polyol is at least one selected from the group consisting of ethylene glycol, propylene glycol, butylene glycol, and glycerol.

11. The pulp as claimed in claim 9, wherein the cooking agent is at least one selected from the group consisting of formic acid, acetic acid, methanol, ethanol, sodium sulfide, sodium sulfite, and sodium hydroxide.

12. The pulp as claimed in claim 9, wherein a ratio of a mass of the cooking agent to a total mass of the lignin precursor organic compound and the polyol is in a range of (7-8):(1-1.5).

13. The pulp as claimed in claim 9, wherein a mass ratio of the lignin precursor organic compound to the polyol ranges from 1:1 to 2:1.

14. The pulp as claimed in claim 9, wherein the high-temperature treatment is conducted at a temperature of 60° C. to 200° C. with a material-to-feed liquid mass ratio of 1:4 to 1:20 for 10 min to 900 min.

15. The pulp as claimed in claim 9, wherein the method further comprises
after the high-temperature treatment, subjecting a resulting mixture to solid-liquid separation to obtain a solid and a black liquor;
preparing a pulp using the solid; and
extracting the lignin and optional hemicellulose from the black liquor, and recycling the cooking agent and the lignin precursor organic compound.

16. The pulp as claimed in claim 9, wherein the lignocellulose raw material comprises a wood and a non-wood fiber raw material;
optionally, the wood is at least one selected from the group consisting of aspen wood, eucalyptus wood, and acacia wood;
optionally, the non-wood fiber raw material is at least one selected from the group consisting of bamboo, rice straw, wheat straw, and corn stalk.

17. A lignin prepared by the method as claimed in claim 1.
